(19) United States
(12) Patent Application Publication
(10) Pub. No.: US 2022/0214030 A1
(43) Pub. Date: Jul. 7, 2022

(54) Stick-On Lamp Board and Uses Thereof

(71) Applicant: ZhiSheng Xu, Philadelphia, PA (US)

(72) Inventor: ZhiSheng Xu, Philadelphia, PA (US)

(73) Assignee: GVM Photographic Equipment Inc., Philadelphia, PA (US)

(21) Appl. No.: 17/143,497

(22) Filed: Jan. 7, 2021

(51) Int. Cl. F21V 21/08; F21V 23/00

(52) U.S. Cl. CPC F21V 21/0808; F21Y 2115/10; F21V 23/005

(57) ABSTRACT

Provided herein are LED arrays and LED lamp boards, for example, a stick-on lamp board. Each LED array or stick-on lamp board has a printed circuit board to which are mounted a combination of lamp bead types operably connected to the circuit board and a power supply operably connected to the printed circuit. The LED arrays and stick-on lamp beads may be removably or permanently secured to a surface. Also provided are sets and lighting systems of two or more of the LED arrays or stick-on lamp boards.

### BACKGROUND OF THE INVENTION

### Field of the Invention

The present invention relates to the fields of lighting systems and light-emitting diodes (LED). More particularly, the present invention relates to LED based lamps utilizing a combination of LED types.

### Description of the Related Art

Light emitting diodes (LEDs) work on the principle of passing a current through semiconductors. Through the combination of electrons and holes, excess energy is released in the form of light to achieve the effect of light emission. LEDs have many advantages in the field of lighting due to their longer life expectancy, low power consumption, fast response time, small size and light weight. In addition to their easily controllable dimming characteristics, they are available in a variety of colors.

Moreover, the components required to manufacture LEDs do not contain environmental pollutants like mercury and lead. Currently, LED based lighting systems use either surface mounted devices (SMD) LEDs, which have flooding and light performance features, or Direct In-line Package (DIP) LEDs (also known as straw hat lamp LEDs), which demonstrate high brightness and condensing performance.

There is, therefore, a need in the art for a lighting device that can combine the properties of both Surface Mounted Devices LEDs and Direct In-line Package LEDs.

The present invention fulfills this long-standing need and desire in the art.

### SUMMARY OF THE INVENTION

The present invention is directed to a light emitting diode (LED) array. The LED array has a printed circuit board to which a plurality of LEDs comprising a combination of lamp bead types are fixedly mounted on a top side of the printed circuit board and are operably connected therewith. A power supply is operably connected to the circuit board. The present invention is directed to a related LED array further comprising means for removably securing the printed circuit board to a surface disposed on a bottom side of the circuit board.

The present invention also is directed to a set of LED lamp boards. The LED lamp boards comprise at least two of the LED arrays as described herein. A means for removably securing each of the at least two LED arrays to a surface is disposed on a bottom side of each.

The present invention is directed further to a stick-on lamp board. The stick-on lamp board has a printed circuit board comprising a top side and a bottom side. A combination of SMD lamp beads and DIPS lamp beads is fixedly mounted in a geometric pattern on the front side of the printed circuit board and operably connected therewith. A means for removably securing the printed circuit board to a surface is disposed on a bottom side thereof.

The present invention is directed further still to a set of LED lamp boards. The set comprises at least two of the stick-on lamp boards as described herein.

The present invention is directed further still to an LED lighting system. The LED lighting system comprises at least one of a first stick-on lamp board, a first stick-on lamp board, a first stick-on lamp board, a first stick-on lamp board, or a first stick-on lamp board, or a combination thereof. Each of stick-on lamp boards has a plurality of SMD lamp beads and DIPS lamp beads fixedly mounted on a top side thereof in, respectively, diamond patterns, triangular patterns, circular patterns, hexagonal patterns, or a concentric ring pattern, and in operable connection therewith.

Other and further aspects, features, benefits, and advantages of the present invention will be apparent from the following description of the presently preferred embodiments of the invention given for the purpose of disclosure.

### BRIEF DESCRIPTION OF THE FIGURES

FIGS. 1A-1B illustrate a first arrangement of SMD lamp beads and DIPS lamp beads on a printed circuit board. FIG. 1A shows a rectangular shaped printed circuit board with SMD lamp beads and the DIPS lamp beads mounted thereon. FIG. 1B illustrates how the SMD lamp beads and the DIPS lamp beads are mounted to form a plurality of diamond patterns.

FIGS. 2A-2B illustrate a second arrangement of SMD lamp beads and DIPS lamp beads on a printed circuit board. FIG. 2A shows a rectangular shaped printed circuit board similar to that in FIG. 1A with SMD lamp beads and the DIPS lamp beads mounted thereon. FIG. 2B illustrates how the SMD lamp beads and the DIPS lamp beads are mounted to form a plurality of triangular patterns.

FIGS. 3A-3B illustrate a third arrangement of SMD lamp beads and DIPS lamp beads on a printed circuit board. FIG. 3A shows a disk shaped printed circuit board with SMD lamp beads and the DIPS lamp beads mounted thereon. FIG. 3B illustrates how the SMD lamp beads and the DIPS lamp beads are mounted to form a circular pattern.

FIGS. 4A-4B illustrate a fourth arrangement of SMD lamp beads and DIPS lamp beads on a printed circuit board. FIG. 4A shows a hexagonal shaped printed circuit board with SMD lamp beads and the DIPS lamp beads mounted thereon. FIG. 3B illustrates how the SMD lamp beads and the DIPS lamp beads are mounted to form a plurality of hexagonal patterns.

FIGS. 5A-5B illustrate a third arrangement of SMD lamp beads and DIPS lamp beads on a printed circuit board. FIG. 5A shows a ring shaped printed circuit board with SMD lamp beads and the DIPS lamp beads mounted thereon. FIG. 5B illustrates how the SMD lamp beads and the DIPS lamp beads are mounted to form a concentric ring pattern.

### DETAILED DESCRIPTION OF THE INVENTION

As used herein, the term “a” or “an” when used in conjunction with the term “comprising” in the claims and/or the specification may mean “one,” but it is also consistent with the meaning of “one or more,” “at least one,” and “one or more than one.” Some embodiments of the invention may consist of or consist essentially of one or more elements, method steps, and/or methods of the invention. It is contemplated that any method described herein can be implemented with respect to any other method described herein.

As used herein, the term “or” in the claims is used to mean “and/or” unless explicitly indicated to refer to alternatives only or the alternatives are mutually exclusive, although the disclosure supports a definition that refers to only alternatives and “and/or.”

As used herein, “comprise” and its variations, such as “comprises” and “comprising,” will be understood to imply the inclusion of a stated item, element or step or group of items, elements or steps but not the exclusion of any other item, element or step or group of items, elements or steps unless the context requires otherwise. Similarly, “another” or “other” may mean at least a second or more of the same or different claim element or components thereof.

As used herein, the terms “printed circuit board” and “circuit board” are interchangeable.

As used herein, the terms “mounted” and “fixedly mounted” in referring to the disposition of the lamp beads on the printed circuit board are interchangeable.

As used herein, the term “stick-on” refers to any means for permanently or removably attaching the LED array or LED lamp board to a surface, including, but not limited to, an adhesive, VELCRO, or hardware, for example, LED light hangars, all of which are well-known and standard in the art.

In one embodiment of the present invention there is provided a light emitting diode (LED) array, comprising a printed circuit board; a plurality of LEDs comprising a combination of lamp bead types fixedly mounted to a top side of the printed circuit board and operably connected therewith; and a power supply operably connected to the circuit board. Further to this embodiment the LED array comprises means for removably securing the printed circuit board to a surface disposed on a bottom side thereof.

In both embodiments the printed circuit board may have a polygonal shape, a disk shape or a ring shape. Particularly, the polygonal shape may be a diamond, a square, a rectangle, a hexagon, or a triangle. Also in both embodiments the combination of lamp bead types may be uniformly arranged on the top side of the printed circuit board to correspond to the shape thereof.

In both embodiments the combination of lamp bead types may be a combination of surface mounted devices (SMD) lamp beads and direct In-line package (DIP) lamp beads. Also, the combination of lamp bead types may be arranged in geometric patterns on the printed circuit board. Particularly, the combination of lamp bead types may be arranged in diamond patterns, triangular patterns, hexagonal patterns, in a circular pattern or in a concentric ring pattern.

In a related embodiment the present invention there is provided to a set of LED lamp boards, comprising at least two of the LED arrays as described supra; and means for removably attaching each of the at least two LED arrays to a surface disposed on a bottom side of each.

In another embodiment of the present invention there is provided a stick-on lamp board comprising a printed circuit board comprising a top side and a bottom side; a combination of SMD lamp beads and DIPS lamp beads fixedly mounted in a geometric pattern on the front side of the printed circuit board and operably connected therewith; and means for removably securing the printed circuit board to a surface disposed on a bottom side thereof.

In this embodiment the printed circuit board may have a polygonal shape, a disk shape or a ring shape. Particularly, the printed circuit board may have a polygonal shape that is a diamond shape, a square shape, a rectangular shape, a hexagonal shape, or a triangular shape. Also, the combination of SMD lamp beads and DIPS lamp beads may be uniformly arranged on the top side of the printed circuit board to correspond to the shape thereof. In addition the combination of SMD lamp beads and DIPS lamp beads may be mounted in diamond patterns, in triangular patterns, in hexagonal patterns, in a circular pattern or in a concentric ring pattern.

In a related embodiment the present invention provides a set of LED lamp boards, comprising at least two of the stick-on lamp boards as described supra.

In yet another embodiment of the present invention there is provided a LED lighting system, comprising at least one of a first stick-on lamp board with a plurality of SMD lamp beads and DIP lamp beads fixedly mounted to a top side thereof in diamond patterns in operable connection therewith; a second stick-on lamp board with a plurality of SMD lamp beads and DIP lamp beads fixedly mounted to a top side thereof in triangular patterns in operable connection therewith; a third stick-on lamp board with a plurality of SMD lamp beads and DIP lamp beads fixedly mounted to a top side thereof in circular patterns in operable connection therewith; a fourth stick-on lamp board with a plurality of SMD lamp beads and DIP lamp beads fixedly mounted to a top side thereof in hexagonal patterns in operable connection therewith; or a fifth stick-on lamp board with a plurality of SMD lamp beads and DIP lamp beads fixedly mounted to a top side thereof in a concentric ring pattern in operable connection therewith; or a combination thereof.

In this embodiment each of the first, second, third, fourth, and fifth stick-on lamp boards comprises on a bottom side thereof means for removably securing the stick-on lamp board to a surface. In one aspect of this embodiment the first stick-on lamp board and the second stick-on lamp board independently may have a rectangular shape or a square shape. In another aspect of this embodiment the third stick-on lamp board and the fifth stick-on lamp board independently may have a disk shape or a ring shape. In yet another aspect the fourth stick-on lamp board has a hexagonal shape.

Provided herein are LED arrays, LED lamp boards, for example, stick-on lamp boards, and sets and lighting systems comprising the same. The LED arrays and LED lamp boards comprise a printed circuit board (PCB), a plurality of LEDS that are a combination of lamp bead types mounted to the printed circuit board and a power supply, either external or internal, as is known in the art, operably connected to the printed circuit board. An example of a power supply is a battery.

The printed circuit board is known in the art and commercially available. The circuit board may have any geometric shape. Generally, the geometric shape is a polygonal shape, a disk shape or a ring shape. Particularly, the polygonal shape may be, but is not limited to, a diamond, a square, a rectangle, a hexagon, or a triangle. The printed circuit board, the LED array and the LED lamp boards may comprise a means for removably or permanently securing, attaching, affixing, or mounting the same to a surface, for example, but not limited to, a wall, a ceiling, or other surface inside or outside a building, house or other structure. Examples of such securing means are well-known in the art and include, but are not limited to, an adhesive, VELCRO or hardware for hanging an object.

The combination of lamp bead types may be commercially available surface mounted devices (SMD) LEDs and Direct In-line Package (DIP) LEDs. The SMD LEDs comprise RGB-color features. The lamp beads are fixedly mounted to the circuit board by, for example, soldering, which operably connects the lamp beads to the circuit board and there by to the power supply as is well-known in the art. The lamp beads are uniformly arranged on the circuit board in rows, i.e., linear, or in any non-linear configuration. The lamp beads cover the surface of the printed circuit board such that the overall shape thereof formed on the board corresponds to the geometric shape of the printed circuit board. The lamp beads may be aesthetically arranged on the circuit board. Within the covering of lamp beads on the circuit board, geometric patterns are formed by groupings of the lamp beads in polygonal or circular geometric shapes. In non-limiting examples, the geometric patterns formed by the combination of lamp beads may be diamond patterns, triangular patterns, hexagonal patterns, in a circular pattern or in a concentric ring pattern.

The LED arrays and LED lamp boards provided herein may comprise a set or a lighting system. For example, the set or the lighting system may comprise at least two of the LED arrays or the LED lamp boards, for example, two or more stick-on lamp boards. The set or lighting system may comprise LED arrays or LED lamp boards with the same geometric shape and lamp bead pattern or a combination of geometric shapes and lamp bead patterns. In a non-limiting example, a lighting system may comprise at least one of a rectangular shaped or a square shaped first stick-on lamp board with a diamond pattern of lamp beads, a rectangular shaped or a square shaped second stick-on lamp board with a triangular patterns of lamp beads, a disk shaped or ring shaped third stick-on lamp board with a circular pattern of lamp beads, a hexagonal shaped fourth stick-on lamp board with a hexagonal pattern of lamp beads, or a disk shaped or ring shaped fifth stick-on lamp board with a diamond pattern of lamp beads, or combinations of the first, second, third, fourth, and fifth stick-on lamp boards.

The LED arrays, LED lamp boards and stick-on lamp boards have the beneficial effects of simultaneously combining the high brightness and condensing performance of the direct in-line package LED lamp beads and the flooding and light performance of the surface mounted devices LED lamp beads. Also, the RGB-color features in the SMD lamp beads enable wide practical applications of the stick-on lamp board.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

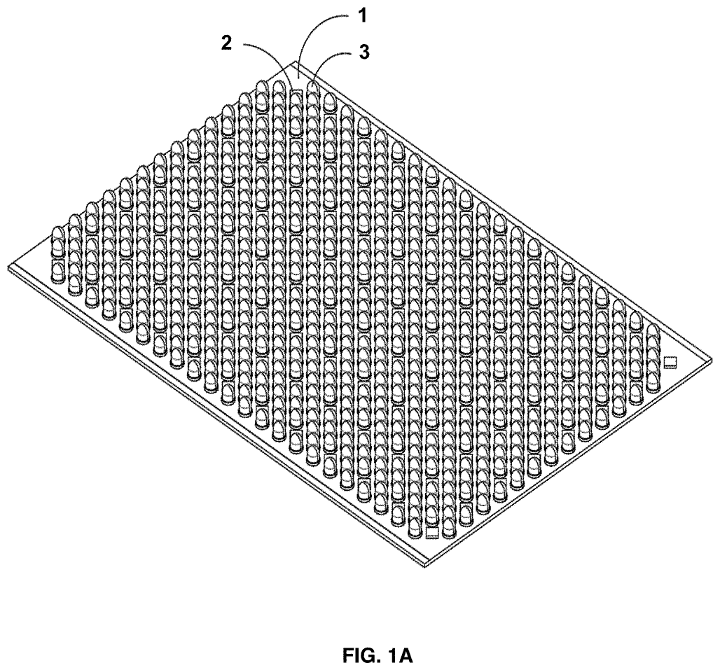

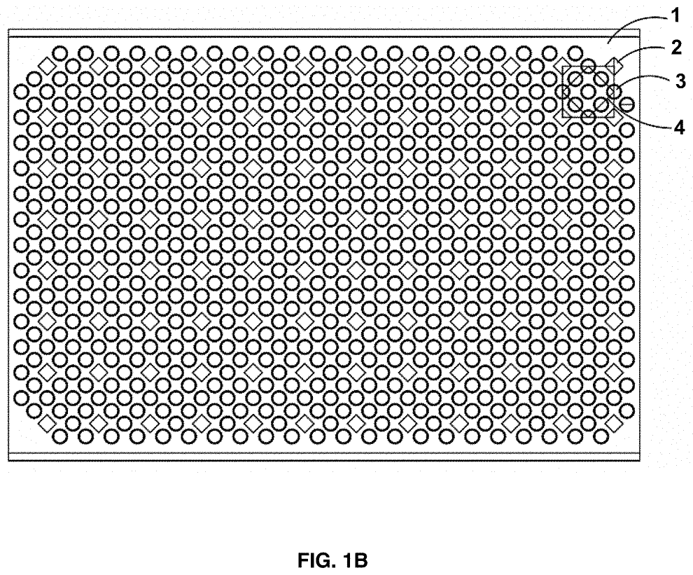

FIG. 1A shows a rectangular shaped printed circuit board 1 upon which are uniformly arranged surface mounted devices (SMD) lamp beads as represented by 2 and direct in-line package (DIP) lamp beads as represented by 3.

With continued reference to FIG. 1A, FIG. 1B illustrates with an outline at 4 how the SMD lamp beads and the DIP lamp beads form diamond patterns on the rectangular shaped printed circuit board.

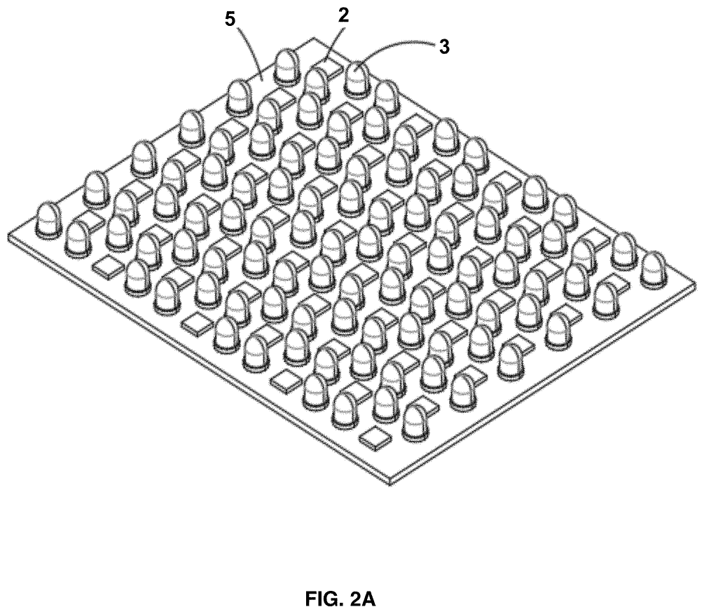

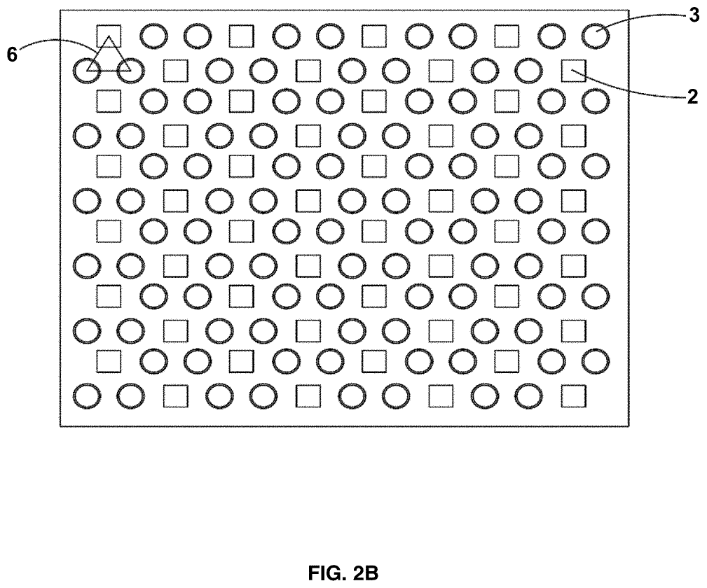

FIG. 2A shows a rectangular shaped printed circuit board 5 upon which are uniformly arranged SMD lamp beads as represented by 2 and DIP lamp beads as represented by 3.

With continued reference to FIG. 2A, FIG. 2B illustrates with an outline at 6 how the SMD lamp beads and the DIP lamp beads form triangular patterns on the rectangular shaped printed circuit board.

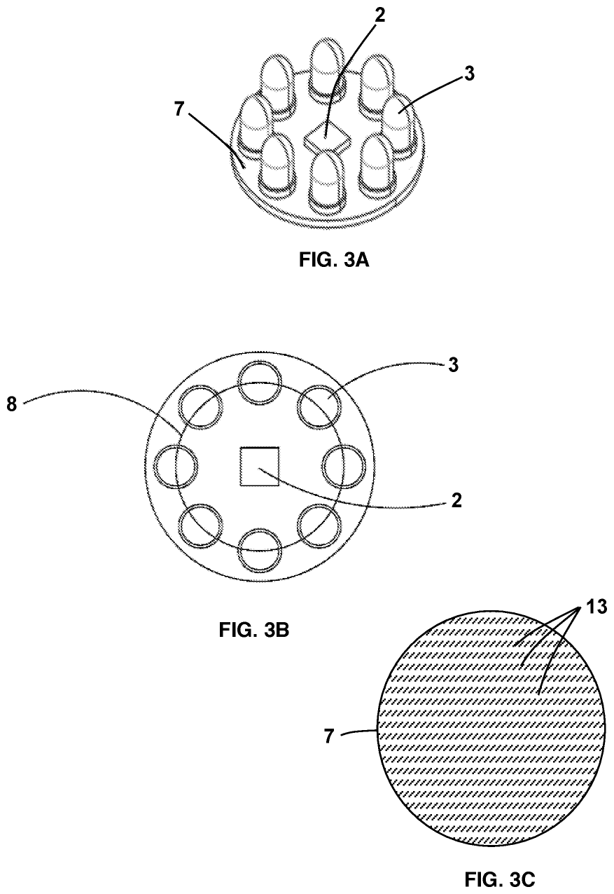

FIG. 3A shows a disked shaped or circular printed circuit board 7 upon which are uniformly arranged SMD lamp beads as represented by 2 and DIP lamp beads as represented by 3.

With continued reference to FIG. 3A, FIG. 3B illustrates with an outline at 8 how the SMD lamp beads and the DIP lamp beads form a circular pattern on the disk shaped printed circuit board.

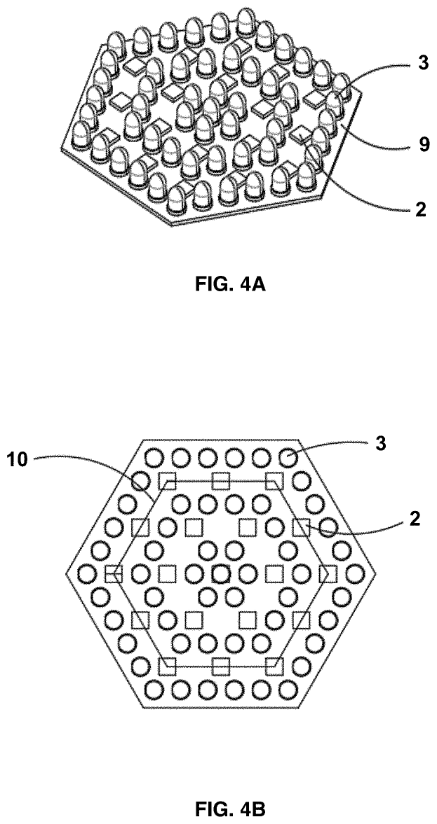

FIG. 4A shows a hexagonal shaped printed circuit board 9 upon which are uniformly arranged SMD lamp beads as represented by 2 and DIP lamp beads as represented by 3.

With continued reference to FIG. 4A, FIG. 4B illustrates with an outline at 10 how the SMD lamp beads and the DIP lamp beads form a hexagonal pattern on the hexagonal shaped printed circuit board.

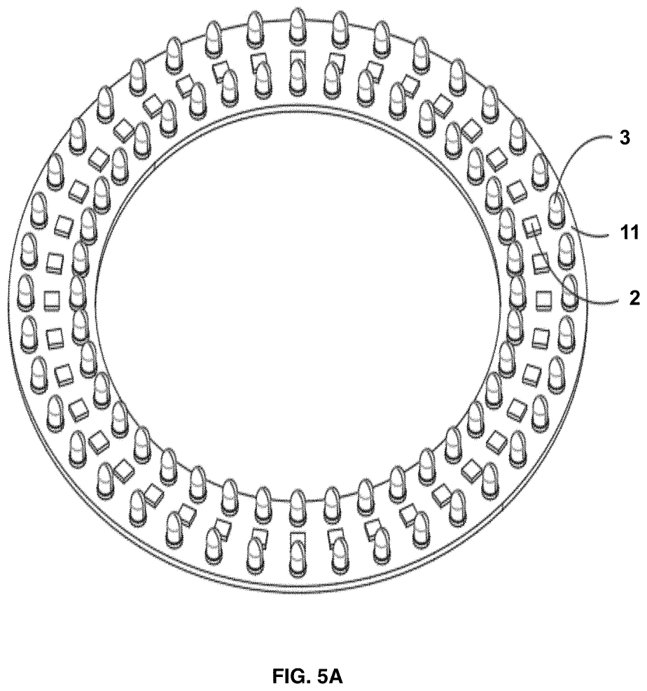

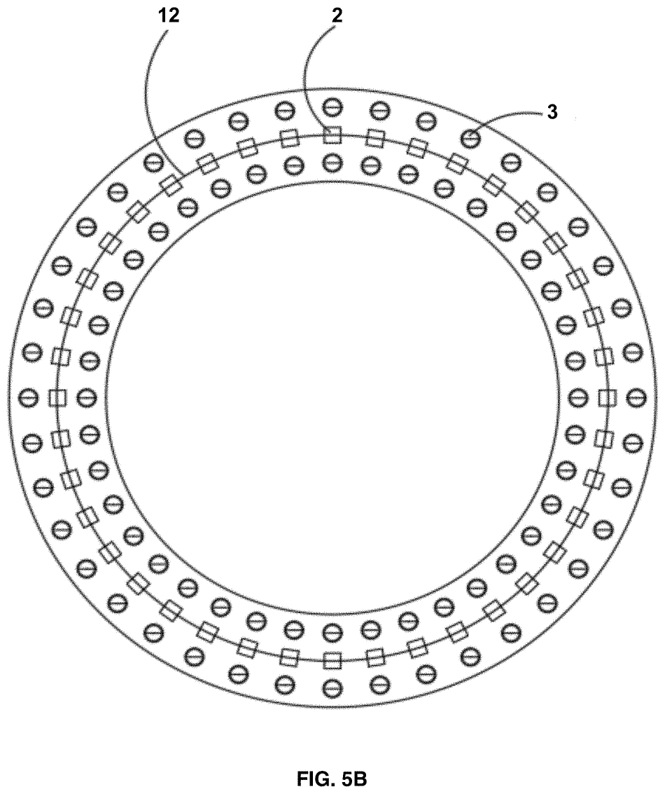

FIG. 5A shows a ring-shaped printed circuit board 11 upon which are uniformly arranged SMD lamp beads as represented by 2 and DIP lamp beads as represented by 3.

With continued reference to FIG. 5A, FIG. 5B illustrates with an outline at 12 how the SMD lamp beads and the DIP lamp beads form a concentric ring pattern on the ring shaped printed circuit board.

1. A light emitting diode (LED) array, consisting of:
a printed circuit board operably connectable to a power source;
a plurality of LEDs that is a combination of lamp bead types fixedly mounted on a top side of the printed circuit board and operably connected therewith; and
an adhesive disposed on a bottom side of the printed circuit board for removably securing the printed circuit board to a surface.

2. (canceled)

3. The LED array of claim 1, wherein the printed circuit board has a polygonal shape, a disk shape, or a ring shape.

4. The LED array of claim 3, wherein the polygonal shape is a diamond, a square, a rectangle, a hexagon, or a triangle.

5. The LED array of claim 3, wherein the combination of lamp bead types is uniformly arranged on the top side of the printed circuit board to correspond to the shape thereof.

6. The LED array of claim 1, wherein the combination of lamp bead types is a combination of surface mounted devices (SMD) lamp beads and direct In-line package (DIP) lamp beads.

7. The LED array of claim 1, wherein the combination of lamp bead types is arranged in geometric patterns on the printed circuit board.

8. The LED array of claim 7, wherein the combination of lamp bead types are arranged in diamond patterns, triangular patterns, hexagonal patterns, in a circular pattern, or in a concentric ring pattern.

9. A set of LED lamp boards, consisting of: at least two of the LED arrays of claim 1.

10. A stick-on lamp board, consisting of:
a printed circuit board with one of a disk shape, a ring shape or a hexagonal shape comprising a top side and a bottom side and connectable to a power source;
a combination of SMD lamp beads and DIP lamp beads fixedly mounted and uniformly arranged on the top side of the printed circuit board to correspond to one of the disk shape, the ring shape, or the hexagonal shape in a circular pattern, a concentric ring pattern, or a hexagonal pattern, respectively, and operably connected therewith; and
an adhesive disposed on the bottom side for removably securing the printed circuit board to a surface.

11-14. (canceled)

15. A set of LED lamp boards, consisting of:
at least two of the stick-on lamp boards of claim 10.

16. An LED lighting system, consisting of:
at least one of:
a first stick-on lamp board with a plurality of SMD lamp beads and DIP lamp beads fixedly mounted to a top side thereof in diamond patterns in operable connection therewith;
a second stick-on lamp board with a plurality of SMD lamp beads and DIP lamp beads fixedly mounted to a top side thereof in triangular patterns in operable connection therewith;
a third stick-on lamp board with a plurality of SMD lamp beads and DIP lamp beads fixedly mounted to a top side thereof in a circular pattern in operable connection therewith;
a fourth stick-on lamp board with a plurality of SMD lamp beads and DIP lamp beads fixedly mounted to a top side thereof in hexagonal patterns in operable connection therewith; or
a fifth stick-on lamp board with a plurality of SMD lamp beads and DIP lamp beads fixedly mounted to a top side thereof in a concentric ring pattern in operable connection therewith;
each of said first, second, third, fourth, and fifth stick-on lamp boards with an adhesive disposed on a bottom side thereof for removably securing each of the stick-on lamp boards to a surface; and
each of said first, second, third, fourth, and fifth stick-on lamp boards operably connectable to a power source.

17. (canceled)

18. The LED lighting system of claim 16, wherein the first stick-on lamp board and the second stick-on lamp board have a rectangular shape.

19. The LED lighting system of claim 16, wherein the third stick-on lamp board and the fifth stick-on lamp board have a disk shape.

20. The LED lighting system of claim 16, wherein the fourth stick-on lamp board has a hexagonal shape.

21. The LED lighting system of claim 16, wherein the third stick-on lamp board and the fifth stick-on lamp board have a ring shape.
